(19) United States
(12) Patent Application Publication
(10) Pub. No.: US 2025/0286460 A1
(43) Pub. Date: Sep. 11, 2025

(54) MULTI-PHASE VOLTAGE REGULATOR OPERABLE WITH FEWER FEEDBACK LOOPS

(71) Applicant: Qorvo US, Inc., Greensboro, NC (US)

(72) Inventor: Masashi Nogawa, Sachse, TX (US)

(21) Appl. No.: 19/046,624

(22) Filed: Feb. 6, 2025

Related U.S. Application Data
(60) Provisional application No. 63/562,760, filed on Mar. 8, 2024.
(60) Provisional application No. 63/656,285, filed on Jun. 5, 2024.

(51) Int. Cl. H02M 3/158; H02M 1/00

(52) U.S. Cl. CPC H02M 3/1584; H02M 1/0009; H02M 1/0025

(57) ABSTRACT

A multi-phase voltage regulator operable with fewer feedback loops is described in the present disclosure. The multi-phase voltage regulator is configured to generate an output current to charge an output capacitor to thereby provide an output voltage. As the name suggests, the output current includes multiple sub-currents each generated by a respective one of multiple sub-current generators. Herein, each of the sub-current generators is configured to self-regulate a respective one of the sub-currents based on an expected level of the output voltage such that each of the sub-currents is substantially identical to each of the other sub-currents. By letting each sub-current generator self-regulate its own sub-current, it is possible to reduce the number of feedback loops in the multi-phase voltage regulator. As a result, the multi-phase voltage regulator can operate with a faster transient response, wider loop bandwidth, increased phase/gain margin, and higher control loop stability.

### RELATED APPLICATIONS

This application claims the benefit of U.S. provisional patent application Ser. No. 63/562,760, filed on Mar. 8, 2024, and U.S. provisional patent application Ser. No. 63/656,285, filed on Jun. 5, 2024, the disclosures of which are hereby incorporated herein by reference in their entireties.

### FIELD OF THE DISCLOSURE

The technology of the disclosure relates generally to a multi-phase DC-DC voltage regulator in an electronic power system.

### BACKGROUND

Electronic power systems are the enabling infrastructure technology that promotes conversion and distribution of electrical power from a power source to electronics and electrical machines. A power conversion circuit is often at the heart of each electronic power system converting electrical power from raw form and quantity as produced by the power source to an appropriate form and quantity as needed by machines, motors, electronic equipment, and so on.

DC-DC conversion has always been an integral element of switch-mode power supplies that operate by toggling a main switch between on—(a.k.a. closed) and off—(a.k.a. open) states. More specifically, the DC-DC conversion can be carried out by a buck (a.k.a. step-down) converter or a boost (a.k.a. step-up) converter. The buck converter passes energy directly to an output with an energy storage inductor providing a continuing current to the output when the main switch is in the off-state, whereas the boost converter stores all the output energy in an inductor when the main switch is in the on-state and passes the stored energy to the output when the main switch is in the off-state.

### SUMMARY

Aspects disclosed in the detailed description are related to a multi-phase voltage regulator operable with fewer feedback loops. The multi-phase voltage regulator is configured to generate an output current to charge an output capacitor to thereby provide an output voltage. As the name suggests, the output current includes multiple sub-currents each generated by a respective one of multiple sub-current generators. Herein, each of the sub-current generators is configured to self-regulate a respective one of the sub-currents based on an expected level of the output voltage such that each of the sub-currents is substantially identical to each of the other sub-currents. By letting each sub-current generator self-regulate its own sub-current, it is possible to reduce the number of feedback loops in the multi-phase voltage regulator. As a result, the multi-phase voltage regulator can operate with a faster transient response, wider loop bandwidth, increased phase/gain margin, and higher control loop stability.

In one aspect, a multi-phase voltage regulator is provided. The multi-phase voltage regulator includes an output capacitor. The output capacitor is coupled to a voltage output and charged by an output current, which includes multiple sub-currents, to provide an output voltage at the voltage output. The multi-phase voltage regulator also includes a voltage control circuit. The voltage control circuit is configured to receive a feedback voltage indicating a present level of the output voltage at the voltage output. The voltage control circuit is also configured to determine a target voltage indicating an expected level of the output voltage based on the feedback voltage and a reference voltage. The multi-phase voltage regulator also includes multiple sub-current generators. Each of the multiple sub-current generators is coupled to the voltage output. Each of the multiple sub-current generators is configured to receive the target voltage from the voltage control circuit. Each of the multiple sub-current generators is configured to extrapolate the expected level of the output current at the voltage output from the target voltage. Each of the multiple sub-current generators is configured to regulate the respective one of the multiple sub-currents based on the expected level of the output current such that the respective one of the multiple sub-currents is substantially identical to each of the other multiple sub-currents comprised in the output current.

In another aspect, a method for operating a multi-phase voltage regulator with fewer feedback loops is provided. The method includes charging an output capacitor by an output current comprising multiple sub-currents to provide an output voltage at a voltage output. The method also includes receiving a feedback voltage indicating a present level of the output voltage at the voltage output. The method also includes determining a target voltage indicating an expected level of the output voltage based on the feedback voltage and a reference voltage. The method also includes extrapolating the expected level of the output current at the voltage output from the target voltage. The method also includes regulating each of the multiple sub-currents based on the expected level of the output current such that the respective one of the multiple sub-currents is substantially identical to each of the other multiple sub-currents comprised in the output current.

In another aspect, an electronic power system is provided. The electronic power system includes a conversion circuit. The conversion circuit is coupled between a power source and a load circuit. The conversion circuit includes a multi-phase voltage regulator. The multi-phase voltage regulator includes an output capacitor. The output capacitor is coupled to a voltage output and charged by an output current, which includes multiple sub-currents, to provide an output voltage at the voltage output. The multi-phase voltage regulator also includes a voltage control circuit. The voltage control circuit is configured to receive a feedback voltage indicating a present level of the output voltage at the voltage output. The voltage control circuit is also configured to determine a target voltage indicating an expected level of the output voltage based on the feedback voltage and a reference voltage. The multi-phase voltage regulator also includes multiple sub-current generators. Each of the multiple sub-current generators is coupled to the voltage output. Each of the multiple sub-current generators is configured to receive the target voltage from the voltage control circuit. Each of the multiple sub-current generators is configured to extrapolate the expected level of the output current at the voltage output from the target voltage. Each of the multiple sub-current generators is configured to regulate the respective one of the multiple sub-currents based on the expected level of the output current such that the respective one of the multiple sub-currents is substantially identical to each of the other multiple sub-currents comprised in the output current.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure and, together with the description, serve to explain the principles of the disclosure.

FIG. 1 is a schematic diagram of an exemplary existing multi-phase voltage regulator operable with three feedback loops;

FIG. 2 is a schematic diagram of an exemplary multi-phase voltage regulator configured according to an embodiment of the present disclosure to operate with fewer feedback loops than the existing multi-phase voltage regulator of FIG. 1;

FIG. 3 is a schematic diagram of an exemplary voltage control circuit in the multi-phase voltage regulator of FIG. 2;

FIG. 4 is a graphic diagram illustrating a load line curve employed by the voltage control circuit of FIG. 3A;

FIG. 5 is a schematic diagram of an exemplary current determination circuit that can be provided in the multi-phase voltage regulator of FIG. 2 to determine and report an output current in the multi-phase voltage regulator of FIG. 2;

FIG. 6 is a schematic diagram of an exemplary electronic power system wherein the multi-phase voltage regulator of FIG. 2 can be provided; and

FIG. 7 is a flowchart of an exemplary process whereby the multi-phase voltage regulator of FIG. 2 can be configured to operate with fewer feedback loops.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description are related to a multi-phase voltage regulator operable with fewer feedback loops. The multi-phase voltage regulator is configured to generate an output current to charge an output capacitor to thereby provide an output voltage. As the name suggests, the output current includes multiple sub-currents each generated by a respective one of multiple sub-current generators. Herein, each of the sub-current generators is configured to self-regulate a respective one of the sub-currents based on an expected level of the output voltage such that each of the sub-currents is substantially identical to each of the other sub-currents. By letting each sub-current generator self-regulate its own sub-current, it is possible to reduce the number of feedback loops in the multi-phase voltage regulator. As a result, the multi-phase voltage regulator can operate with a faster transient response, wider loop bandwidth, increased phase/gain margin, and higher control loop stability.

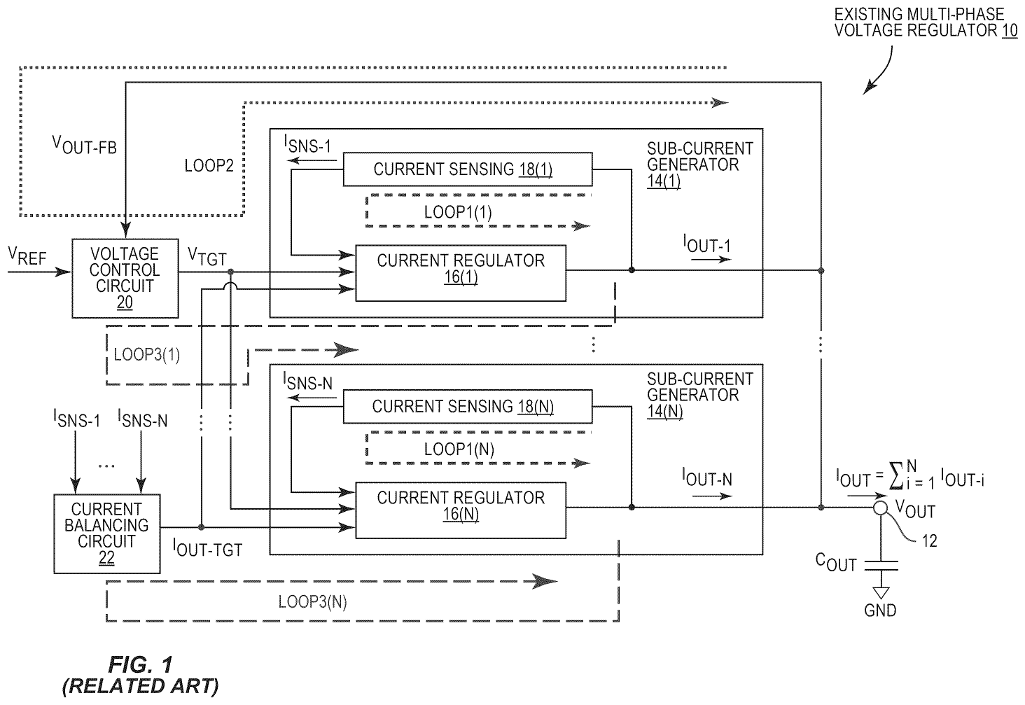

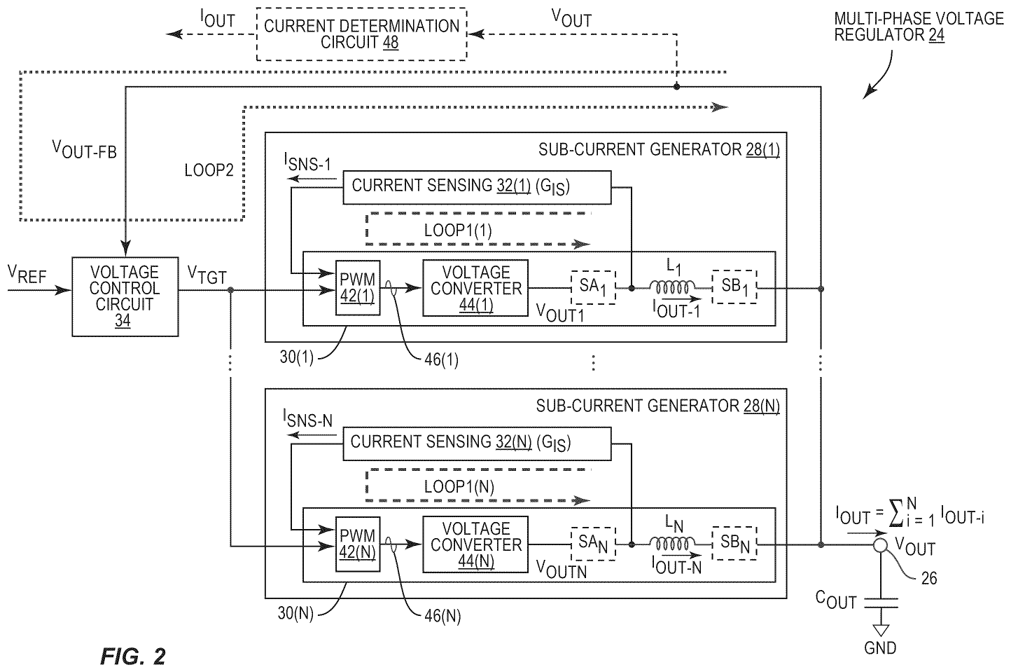

Before discussing a multi-phase voltage regulator of the present disclosure, starting at FIG. 2, a brief overview of an existing multi-phase voltage regulator is first provided with reference to FIG. 1 to help identify the technical problems to be solved herein.

FIG. 1 is a schematic diagram of an exemplary existing multi-phase voltage regulator 10 operable based on a set of first feedback loops Loop1(1)-Loop1(N), a second feedback loop Loop2, and a set of third feedback loops Loop3(1)-Loop3(N). The existing multi-phase voltage regulator 10 includes an output capacitor C_{OUT}. Herein, the output capacitor C_{OUT} is coupled to a voltage output 12 and charged by an output current I_{OUT} to provide an output voltage V_{OUT} at the voltage output 12.

As the name “multi-phase voltage regulator” suggests, the output current I_{OUT} is a multi-phase current that includes multiple sub-currents I_{OUT-1}-I_{OUT-N}(I_{OUT}=Σᵢ₌₁^{N}I_{OUT-i}). Each of the sub-currents I_{OUT-1}-I_{OUT-N} is generated by a respective one of multiple sub-current generators 14(1)-14(N). Specifically, each of the sub-current generators 14(1)-14(N) includes a respective one of multiple current regulators 16(1)-16(N) and a respective one of multiple current sensing circuits 18(1)-18(N).

Each of the current sensing circuits 18(1)-18(N) is part of a respective one of the set of first feedback loops Loop1(1)-Loop1(N) and configured to generate a respective one of multiple sense currents I_{SNS-1}-I_{SNS-N}. Each of the sense currents I_{SNS-1}-I_{SNS-N} is generated to indicate a present level of a respective one of the sub-currents I_{OUT-1}-I_{OUT-N} at the voltage output 12. In an embodiment, each of the sense currents I_{SNS-1}-I_{SNS-N} may be proportionally related to the respective one of the sub-currents I_{OUT-1}-I_{OUT-N} based on a scaling factor, which can be less than or equal to one.

The existing multi-phase voltage regulator 10 also includes a voltage control circuit 20. The voltage control circuit 20 is configured to receive a feedback voltage V_{OUT-FB} via the second feedback loop Loop2. The feedback voltage V_{OUT-FB} provides an indication of the present level of the output voltage V_{OUT} at the voltage output 12. The voltage control circuit 20 is configured to compare the feedback voltage V_{OUT-FB} against a reference voltage V_{REF} to thereby determine a target voltage V_{TGT} that indicates an expected level of the output voltage V_{OUT}. The voltage control circuit 20 then provides the target voltage V_{TGT} to each of the current regulators 16(1)-16(N). Each of the current regulators 16(1)-16(N), in turn, generates the respective one of the sub-currents I_{OUT-1}-I_{OUT-N} in accordance with the target voltage V_{TGT} and the respective one of the sense currents I_{SNS-1}-I_{SNS-N}.

In the existing multi-phase voltage regulator 10, it is desirable for the sub-currents I_{OUT-1}-I_{OUT-N} to be substantially identical to each other. To balance the sub-currents I_{OUT-1}-I_{OUT-N} across the sub-current generators 14(1)-14(N), a current balancing circuit 22 is provided in the existing multi-phase voltage regulator 10. The current balancing circuit 22 is configured to receive the sense currents I_{SNS-1}-I_{SNS-N} via the set of third feedback loops Loop3(1)-Loop3(N), respectively, and generate a target current I_{OUT-TGT} to indicate an expected sum of the sub-currents I_{OUT-1}-I_{OUT-N}. Accordingly, the current balancing circuit 22 can cause each of the sub-currents I_{OUT-1}-I_{OUT-N} to be adjusted to an equal amount.

Notably, the current balancing circuit 22 and the set of third feedback loops Loop3(1)-Loop3(N) can lead to a more complex implementation and potentially hinder the ability of the existing multi-phase voltage regulator 10 to respond quickly to transient events. As such, it is desirable to eliminate the current balancing circuit 22 and the set of third feedback loops Loop3(1)-Loop3(N) to help improve the response time of the existing multi-phase voltage regulator 10.

In this regard, FIG. 2 is a schematic diagram of an exemplary multi-phase voltage regulator 24 configured according to an embodiment of the present disclosure to operate with only a set of first feedback loops Loop1(1)-Loop1(N) and a second feedback loop Loop2. As described below, by eliminating the set of third feedback loops Loop3(1)-Loop3(N) and reconfiguring the voltage control circuit 20 in the existing multi-phase voltage regulator 10 of FIG. 1, the multi-phase voltage regulator 24 is able to provide a faster response to the transient event than the existing multi-phase voltage regulator 10.

Like the existing multi-phase voltage regulator 10, the multi-phase voltage regulator 24 also includes an output capacitor C_{OUT}. The output capacitor C_{OUT} is coupled to a voltage output 26 and charged by an output current I_{OUT} to provide an output voltage V_{OUT} at the voltage output 26.

Like the output current I_{OUT} in the existing multi-phase voltage regulator 10, the output current I_{OUT} is also a multi-phase current that includes multiple sub-currents I_{OUT-1}-I_{OUT-N} (I_{OUT}=Σᵢ₌₁^{N}I_{OUT-i}). Each of the sub-currents I_{OUT-1}-I_{OUT-N} is generated by a respective one of multiple sub-current generators 28(1)-28(N). Specifically, each of the sub-current generators 28(1)-28(N) includes a respective one of multiple current regulators 30(1)-30(N) and a respective one of multiple current sensing circuits 32(1)-32(N).

Each of the current sensing circuits 32(1)-32(N) is associated with a current sense gain G_{IS} and is part of a respective one of the set of first feedback loops Loop1(1)-Loop1(N). Similar to the current sensing circuits 18(1)-18(N), each of the current sensing circuits 32(1)-32(N) is also configured to generate a respective one of multiple sense currents I_{SNS-1}-I_{SNS-N} that indicates a present level of a respective one of the sub-currents I_{OUT-1}-I_{OUT-N} at the voltage output 26. Herein, each of the sense currents I_{SNS-1}-I_{SNS-N} may be proportionally related to the respective one of the sub-currents I_{OUT-1}-I_{OUT-N} based on a scaling factor, which can be less than or equal to one.

The multi-phase voltage regulator 24 also includes a voltage control circuit 34. The voltage control circuit 34 is configured to receive a feedback voltage V_{OUT-FB} via the second feedback loop Loop2 (a.k.a. output voltage feedback loop). The feedback voltage V_{OUT-FB} provides an indication of the present level of the output voltage V_{OUT} at the voltage output 26. The voltage control circuit 34 is configured to compare the feedback voltage V_{OUT-FB} against a reference voltage V_{REF} to thereby determine a target voltage V_{TGT} that indicates an expected level of the output voltage V_{OUT}. The voltage control circuit 34 then provides the target voltage V_{TGT} to each of the current regulators 30(1)-30(N).

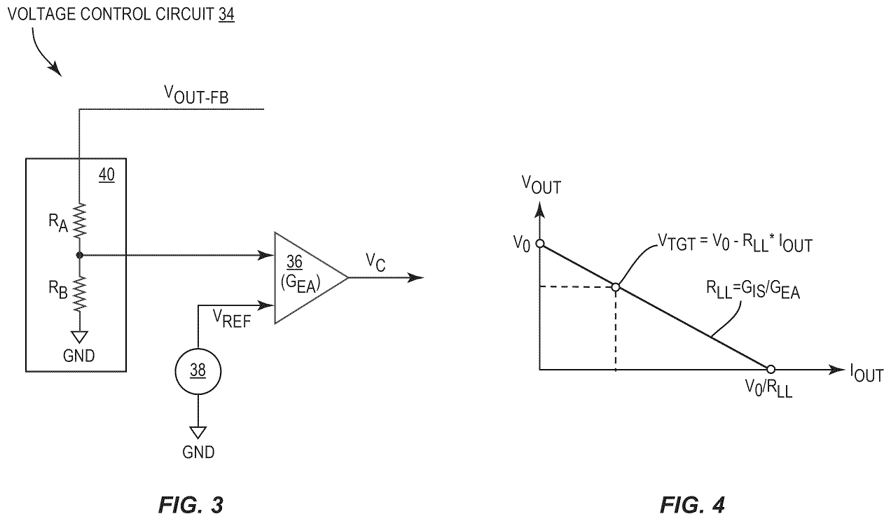

FIG. 3 is a schematic diagram providing an exemplary illustration of the voltage control circuit 34. Common elements between FIGS. 2 and 3 are shown therein with common element numbers and will not be re-described herein.

In an embodiment, the voltage control circuit 34 includes an error amplifier 36, a voltage source 38, and a voltage divider 40. The voltage source 38 is configured to provide the reference voltage V_{REF} to the error amplifier 36. The voltage divider 40, which includes a pair of resistors R_{A} and R_{B}, is configured to provide a portion of the feedback voltage V_{OUT-FB} to the error amplifier 36. The error amplifier 36, which is associated with a voltage error gain G_{EA}, is configured to generate the target voltage V_{TGT} as a function of the output current I_{OUT}. More specifically, the error amplifier 36 can generate the target voltage V_{TGT} in accordance with equation (Eq. 1) below.

$${V}_{TGT} = {V}_{0} - {R}_{LL} * {I}_{OUT} \qquad ( Eq . 1 )$$

In the equation (Eq. 1), V₀ represents a value of the output voltage V_{OUT} when the output current I_{OUT} is equal to zero, R_{LL} represents a load line of the multi-phase voltage regulator 24, and I_{OUT} represents an expected level of the output current I_{OUT}. The equation (Eq. 1) can be better visualized via a load line curve, as illustrated in FIG. 4.

With reference to FIG. 4, the load line R_{LL} can be determined by the current sense gain G_{IS} and the voltage error gain G_{EA}, as shown in equation (Eq. 2) below.

$${R}_{LL} = {G}_{IS} / {G}_{EA} \qquad ( Eq . 2 )$$

With reference back to FIG. 2, because the target voltage V_{TGT} is now a function of the output current I_{OUT}, each of the current regulators 30(1)-30(N) can thus extrapolate the output current I_{OUT} from the target voltage V_{TGT}. Accordingly, each of the current regulators 30(1)-30(N) can self-regulate a respective one of the sub-currents I_{OUT-1}-I_{OUT-N} to be substantially identical to each of the other sub-currents I_{OUT-1}-I_{OUT-N}. In the context of the present disclosure, the sub-currents I_{OUT-1}-I_{OUT-N} are said to be substantially identical to one another when a respective difference between each of the sub-currents I_{OUT-1}-I_{OUT-N} is within plus-minus one percent (≤±1%). As a result, it is possible to eliminate the current balancing circuit 22 and the set of third feedback loops Loop3(1)-Loop3(N) from the multi-phase voltage regulator 24.

In an embodiment, each of the current regulators 30(1)-30(N) includes a respective one of multiple controllers 42(1)-42(N), a respective one of multiple voltage converters 44(1)-44(N), a respective one of multiple first switching devices SA₁-SA_{N}, a respective one of multiple second switching devices SB₁-SB_{N}, and a respective one of multiple power inductors L₁-L_{N}. In an embodiment, each of the controllers 42(1)-42(N) can be a pulse-width modulation (PWM) controller. Herein, each of the controllers 42(1)-42(N) is configured to receive the target voltage V_{TGT} from the voltage control circuit 34. Each of the controllers 42(1)-42(N) also receives a respective one of the sense currents I_{SNS-1}-I_{SNS-N} via a respective one of the set of first feedback loops Loop1(1)-Loop1(N).

Each of the controllers 42(1)-42(N) can thus extrapolate the expected level of the output current I_{OUT} at the voltage output 26 from the target voltage V_{TGT} and determine an expected level of the respective one of the sub-currents I_{OUT-1}-I_{OUT-N}. By comparing the expected level of the respective one of the sub-currents I_{OUT-1}-I_{OUT-N} against the present level of the respective one of the sub-currents I_{OUT-1}-I_{OUT-N} as indicated by the respective one of the sense currents I_{SNS-1}-I_{SNS-N}, each of the controllers 42(1)-42(N) can then determine an adjustment value to the respective one of the sub-currents I_{OUT-1}-I_{OUT-N}. Subsequently, each of the controllers 42(1)-42(N) can generate a respective one of the duty cycle signals 46(1)-46(N).

The voltage converters 44(1)-44(N) can each be a buck converter, a boost converter, or a buck-boost converter. Each of the voltage converters 44(1)-44(N) is configured to generate a respective one of multiple sub-voltages V_{OUT-1}-V_{OUT-N} in accordance with a respective one of the duty cycle signals 46(1)-46(N).

In a non-limiting example, each of the first switching devices SA₁-SA_{N} and the second switching devices SB₁-SB_{N} can be implemented by a semiconductor transistor, such as a metal-oxide semiconductor field-effect transistor (MOSFET). When each of the voltage converters 44(1)-44(N) is operating as the buck converter, only the first switching devices SA₁-SA_{N} are provided in the current regulators 30(1)-30(N). In contrast, when each of the voltage converters 44(1)-44(N) is operating as the boost converter, only the second switching devices SB₁-SB_{N} are provided in the current regulators 30(1)-30(N). In case each of the voltage converters 44(1)-44(N) is operating as the buck-boost converter, both the first switching devices SA₁-SA_{N} and the second switching devices SB₁-SB_{N} are provided in the current regulators 30(1)-30(N).

In an embodiment, each of the first switching devices SA₁-SA_{N} may be toggled based on a respective one of the duty cycle signals 46(1)-46(N) to couple a respective one of the voltage converters 44(1)-44(N) to a respective one of the power inductors L₁-L_{N} such that the respective one of the power inductors L₁-L_{N} can generate a respective one of the sub-currents I_{OUT-1}-I_{OUT-N} based on a respective one of the sub-voltages V_{OUT-1}-V_{OUT-N}. Likewise, each of the second switching devices SB₁-SB_{N} may also be toggled based on a respective one of the duty cycle signals 46(1)-46(N) to couple a respective one of the power inductors L₁-L_{N} to the voltage output 26 such that the respective one of the power inductors L₁-L_{N} can provide a respective one of the sub-currents I_{OUT-1}-I_{OUT-N} to the voltage output 26.

In addition to configuring each of the current regulators 30(1)-30(N) to self-regulate the respective one of the sub-currents I_{OUT-1}-I_{OUT-N} to be substantially identical to each of the other sub-currents I_{OUT-1}-I_{OUT-N}, the multi-phase voltage regulator 24 may be required to report the output current I_{OUT} to help control a corresponding electronic power system in accordance with performance and/or regulatory requirements. In this regard, the multi-phase voltage regulator 24 may further include a current determination circuit 48. According to an embodiment of the present disclosure, the current determination circuit 48 can be configured to calculate the output current I_{OUT} and report the output current I_{OUT} to circuitries located outside the multi-phase voltage regulator 24.

According to the equation (Eq. 1), the output current I_{OUT} can be calculated based on the feedback V_{OUT-FB} that indicates the present level of the output voltage V_{OUT} in conjunction with a set of configured parameters (V₀ and R_{LL}). As described in FIG. 4, V₀ represents the value of the output voltage V_{OUT} when the output current I_{OUT} is equal to zero and R_{LL} represents the load line of the multi-phase voltage regulator 24. In this regard, if the current determination circuit 48 is made aware of the set of configured parameters (V₀ and R_{LL}) and the feedback V_{OUT-FB} of the output voltage V_{OUT}, the current determination circuit 48 will then be able to calculate the output current I_{OUT} in accordance with equation (Eq. 3) below.

$${I}_{OUT} = ( {V}_{OUT - FB} - {V}_{0} ) / {R}_{LL} \qquad ( Eq . 3 )$$

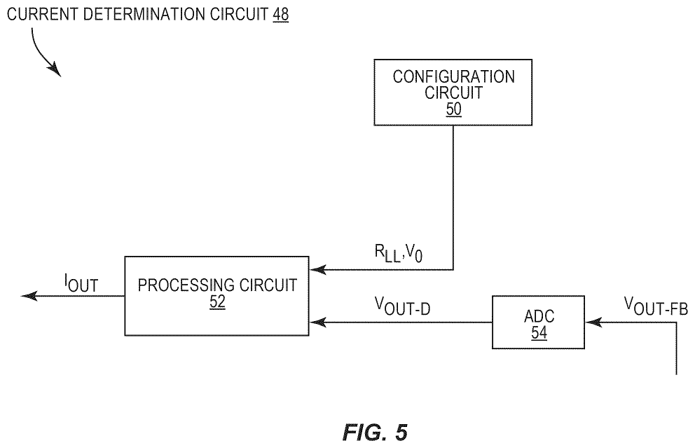

FIG. 5 is a schematic diagram of the current determination circuit 48 configured according to an embodiment of the present disclosure. Common elements between FIGS. 2 and 5 are shown therein with common element numbers and will not be re-described herein.

The current determination circuit 48 can include a configuration circuit 50, a processing circuit 52, and an analog-to-digital converter (ADC) 54. The configuration circuit 50, which can include such storage devices as register and flash memory, can be pre-configured to store the set of configured parameters (V₀, R_{LL}). The ADC 54 may be coupled to the second feedback loop Loop2 to receive the feedback V_{OUT-FB} of the output voltage V_{OUT} and convert the feedback V_{OUT-FB} of the output voltage V_{OUT} into a digital feedback voltage V_{OUT-D}. The processing circuit 52, which can be a general-purpose processor or an application-specific integrated circuit (ASIC), as an example, can be configured to calculate the output current I_{OUT} in accordance with the equation (Eq. 3) above.

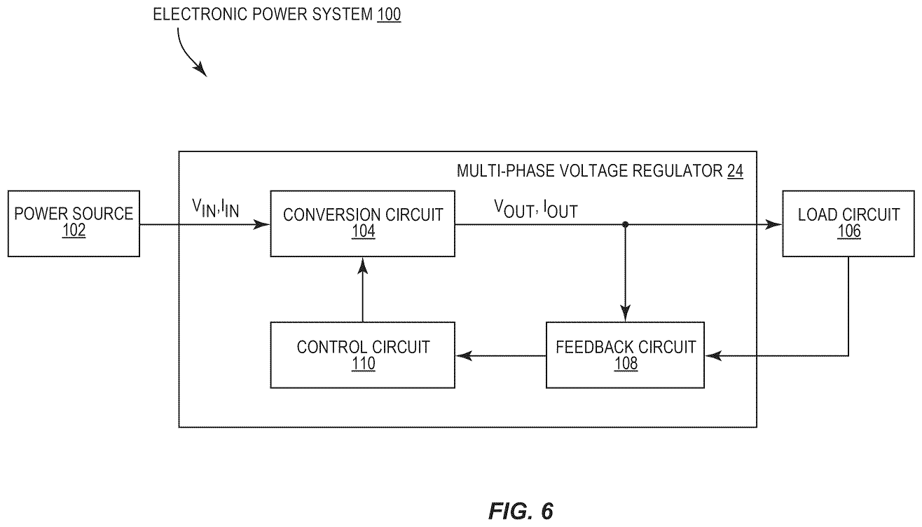

The multi-phase voltage regulator 24 of FIG. 2 can be provided in an electronic power system to perform the functionalities described herein. In this regard, FIG. 6 is a schematic diagram of an exemplary electronic power system 100 wherein the multi-phase voltage regulator 24 of FIG. 2 can be provided.

In an embodiment, the electronic power system 100 includes a power source 102, a conversion circuit 104, a load circuit 106, a feedback circuit 108, and a control circuit 110. The power source 102, which can be an AC or a DC power source, is configured to generate an input voltage V_{IN} and/or an input current I_{IN}.

The conversion circuit 104 is configured to convert the input voltage V_{IN} and/or the input current I_{IN} into an output voltage V_{OUT} and/or an output current I_{OUT}. The conversion circuit 104 may be a step-down converter that converts a higher input voltage V_{IN} and/or a higher input current I_{IN} to a lower output voltage V_{OUT} and/or a lower output current I_{OUT}. The conversion circuit 104 may be a step-up converter that converts a lower input voltage V_{IN} and/or a lower input current I_{IN} to a higher output voltage V_{OUT} and/or a higher output current I_{OUT}. The conversion circuit 104 may also be a step-down and step-up converter that can toggle between step-down and step-up operations in accordance with a duty cycle to produce the output voltage V_{OUT} and/or the output current I_{OUT} at any level.

The load circuit 106 can be any type of electrical circuit, such as an electric vehicle (EV) motor, EV battery, power grid, data center server, and so on. The conversion circuit 104 is configured to provide the output voltage V_{OUT} and/or the output current I_{OUT} to the load circuit 106 via any suitable transmission medium.

The feedback circuit 108 is configured to provide various feedback to the control circuit 110. As an example, the feedback circuit 108 can dynamically measure the output voltage V_{OUT} and/or the output current I_{OUT} being received by the load circuit 106 and report the measurement results to the control circuit 110, either in real time or with hysteresis. The feedback circuit 108 may also monitor operating conditions (e.g., load impedance, operating frequency, thermal temperature, etc.) in the load circuit 106 and report such conditions to the control circuit 110. The control circuit 110, in turn, can dynamically control the conversion circuit 104 to adjust the output voltage V_{OUT} and/or the output current I_{OUT} based on the various feedback provided by the feedback circuit 108.

In an embodiment, the multi-phase voltage regulator 24 may be configured to include the conversion circuit 104, the feedback circuit 108, and the control circuit 110. In an embodiment, the multi-phase voltage regulator 24 may be integrated with the conversion circuit 104. In an embodiment, the multi-phase voltage regulator 24 may be integrated with the control circuit 110.

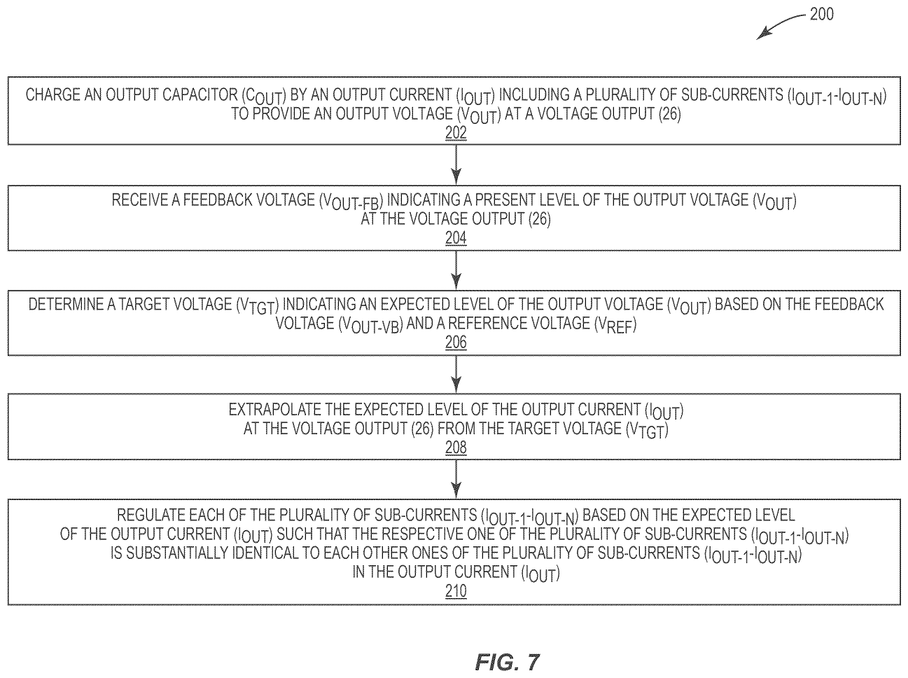

In an embodiment, the multi-phase voltage regulator 24 of FIG. 2 can be operated based on a process. In this regard, FIG. 7 is a flowchart of an exemplary process 200 whereby the multi-phase voltage regulator 24 of FIG. 2 can be configured to operate with fewer feedback loops.

Herein, the process 200 includes charging the output capacitor C_{OUT} by the output current I_{OUT}, which includes the sub-currents I_{OUT-1}-I_{OUT-N} to provide the output voltage V_{OUT} at the voltage output 26 (step 202). The process 200 also includes receiving the feedback voltage V_{OUT-FB} indicating the present level of the output voltage V_{OUT} at the voltage output 26 (step 204). The process 200 also includes determining the target voltage V_{TGT} indicating the expected level of the output voltage V_{OUT} based on the feedback voltage V_{OUT-VB} and the reference voltage V_{REF} (step 206). The process 200 also includes extrapolating the expected level of the output current I_{OUT} at the voltage output 26 from the target voltage V_{TGT} (step 208). The process 200 also includes regulating each of the sub-currents I_{OUT-1}-I_{OUT-N} based on the expected level of the output current I_{OUT} such that the respective one of the sub-currents I_{OUT-1}-I_{OUT-N} is substantially identical to each of the other sub-currents I_{OUT-1}-I_{OUT-N} in the output current I_{OUT} (step 210).

Those skilled in the art will recognize improvements and modifications to the embodiments of the present disclosure. All such improvements and modifications are considered within the scope of the concepts disclosed herein and the claims that follow.

What is claimed is:

1. A multi-phase voltage regulator comprising:
an output capacitor coupled to a voltage output and charged by an output current comprising a plurality of sub-currents to provide an output voltage at the voltage output;
a voltage control circuit configured to:
receive a feedback voltage indicating a present level of the output voltage at the voltage output; and
determine a target voltage indicating an expected level of the output voltage based on the feedback voltage and a reference voltage; and
a plurality of sub-current generators each coupled to the voltage output and configured to:
receive the target voltage from the voltage control circuit;
extrapolate the expected level of the output current at the voltage output from the target voltage; and
regulate the respective one of the plurality of sub-currents based on the expected level of the output current such that the respective one of the plurality of sub-currents is substantially identical to each other one of the plurality of sub-currents comprised in the output current.

2. The multi-phase voltage regulator of claim 1, wherein the voltage control circuit is further configured to determine the target voltage as a function of the output current.

3. The multi-phase voltage regulator of claim 2, wherein the target voltage is expressed as: V_{TGT}=V₀−R_{LL}*I_{OUT}, wherein:
V_{TGT} represents the target voltage;
V₀ represents the output voltage when the output current is zero;
R_{LL} represents a load line of the multi-phase voltage regulator; and
I_{OUT} represents the expected level of the output current.

4. The multi-phase voltage regulator of claim 1, further comprising:
an output voltage feedback loop configured to provide the feedback voltage indicating the present level of the output voltage at the voltage output; and
a plurality of current sensing circuits each configured to generate a respective one of a plurality of sense currents indicating the respective one of the plurality of sub-currents at the voltage output.

5. The multi-phase voltage regulator of claim 4, wherein each of the plurality of sub-current generators comprises a respective one of a plurality of current regulating circuits coupled to a respective one of the plurality of current sensing circuits and configured to:
extrapolate the expected level of the output current at the voltage output from the target voltage;
determine the expected level of the respective one of the plurality of sub-currents;
compare the expected level of the respective one of the plurality of sub-currents against the present level of the respective one of the plurality of sub-currents as indicated by the respective one of the plurality of sense currents to determine an adjustment value to the respective one of the plurality of sub-currents; and
adjust the respective one of the plurality of sub-currents to the expected level based on the determined adjustment value.

6. The multi-phase voltage regulator of claim 5, wherein each of the plurality of current regulating circuits comprises:
a respective voltage converter configured to generate a respective sub-voltage based on the target voltage; and
a respective power inductor configured to induce the respective one of the plurality of sub-currents based on the respective sub-voltage.

7. The multi-phase voltage regulator of claim 6, wherein the respective voltage converter is one of a buck converter, a boost converter, and a buck-boost converter.

8. The multi-phase voltage regulator of claim 6, wherein each of the plurality of current regulating circuits further comprises a respective switching device coupled between the respective voltage converter and the respective power inductor.

9. The multi-phase voltage regulator of claim 1, further comprising a current determination circuit configured to calculate the output current expressed as: I_{OUT}=(V₀−V_{OUT-FB})/R_{LL}, wherein:
I_{OUT} represents the output current calculated by the current determination circuit;
V₀ represents a level of the output voltage when the output current is equal to zero;
V_{OUT-FB} represents the feedback voltage indicating the present level of the output voltage at the voltage output; and
R_{LL} represents a load line of the multi-phase voltage regulator.

10. The multi-phase voltage regulator of claim 9, wherein the current determination circuit comprises:
a configuration circuit configured to store the level of the output voltage when the output current is equal to zero and the load line of the multi-phase voltage regulator; and
a processing circuit configured to calculate the output current based on the level of the output voltage when the output current is equal to zero, the load line of the multi-phase voltage regulator, and the feedback voltage indicating the present level of the output voltage at the voltage output.

11. A method for operating a multi-phase voltage regulator with fewer feedback loops comprising:
charging an output capacitor by an output current comprising a plurality of sub-currents to provide an output voltage at a voltage output;
receiving a feedback voltage indicating a present level of the output voltage at the voltage output;
determining a target voltage indicating an expected level of the output voltage based on the feedback voltage and a reference voltage;
extrapolating the expected level of the output current at the voltage output from the target voltage; and
regulating each of the plurality of sub-currents based on the expected level of the output current such that the respective one of the plurality of sub-currents is substantially identical to each other one of the plurality of sub-currents comprised in the output current.

12. The method of claim 10, further comprising determining the target voltage as a function of the output current.

13. The method of claim 12, wherein determining the target voltage comprises determining the target voltage as being expressed as: V_{TGT}=V₀−R_{LL}*I_{OUT}, wherein:
V_{TGT} represents the target voltage;
V₀ represents the output voltage when the output current is zero;
R_{LL} represents the load line of the multi-phase voltage regulator; and
I_{OUT} represents the expected level of the output current.

14. The method of claim 11, further comprising:
configuring an output voltage feedback loop to provide the feedback voltage indicating the present level of the output voltage at the voltage output; and
configuring each of a plurality of current sensing circuits to generate a respective one of a plurality of sense currents indicating the respective one of the plurality of sub-currents at the voltage output.

15. The method of claim 14, further comprising:
extrapolating the expected level of the output current at the voltage output from the target voltage;
determining the expected level of the respective one of the plurality of sub-currents;
comparing the expected level of the respective one of the plurality of sub-currents against the present level of the respective one of the plurality of sub-currents as indicated by the respective one of the plurality of sense currents to determine an adjustment value to the respective one of the plurality of sub-currents; and
adjusting the respective one of the plurality of sub-currents to the expected level based on the determined adjustment value.

16. The method of claim 11, further comprising calculating the output current as expressed as: I_{OUT}=(V₀−V_{OUT-FB})/R_{LL}, wherein:
I_{OUT} represents the output current as calculated;
V₀ represents a level of the output voltage when the output current is equal to zero;
V_{OUT-FB} represents the feedback voltage indicating the present level of the output voltage at the voltage output; and
R_{LL} represents a load line of the multi-phase voltage regulator.

17. An electronic power system comprising a conversion circuit coupled between a power source and a load circuit, the conversion circuit comprises a multi-phase voltage regulator comprising:
an output capacitor coupled to a voltage output and charged by an output current comprising a plurality of sub-currents to provide an output voltage at the voltage output;
a voltage control circuit configured to:
receive a feedback voltage indicating a present level of the output voltage at the voltage output; and
determine a target voltage indicating an expected level of the output voltage based on the feedback voltage and a reference voltage; and
a plurality of sub-current generators each coupled to the voltage output and configured to:
receive the target voltage from the voltage control circuit;
extrapolate the expected level of the output current at the voltage output from the target voltage; and
regulate the respective one of the plurality of sub-currents based on the expected level of the output current such that the respective one of the plurality of sub-currents is substantially identical to each other one of the plurality of sub-currents comprised in the output current.

18. The electronic power system of claim 17, wherein the voltage control circuit is further configured to determine the target voltage as expressed as: V_{TGT}=V₀−R_{LL}*I_{OUT}, wherein:
V_{TGT} represents the target voltage;
V₀ represents the output voltage when the output current is zero;
R_{LL} represents a load line of the multi-phase voltage regulator; and
I_{OUT} represents the output current.

19. The electronic power system of claim 17, wherein the multi-phase voltage regulator further comprises:
an output voltage feedback loop configured to provide the feedback voltage indicating the present level of the output voltage at the voltage output; and
a plurality of current sensing circuits each configured to generate a respective one of a plurality of sense currents indicating the respective one of the plurality of sub-currents at the voltage output, wherein each of the plurality of sub-current generators comprises a respective one of a plurality of current regulating circuits coupled to a respective one of the plurality of current sensing circuits and configured to:
extrapolate the expected level of the output current at the voltage output from the target voltage;
determine the expected level of the respective one of the plurality of sub-currents;
compare the expected level of the respective one of the plurality of sub-currents against the present level of the respective one of the plurality of sub-currents as indicated by the respective one of the plurality of sense currents to determine an adjustment value to the respective one of the plurality of sub-currents; and
adjust the respective one of the plurality of sub-currents to the expected level based on the determined adjustment value.

20. The electronic power system of claim 17, wherein the multi-phase voltage regulator further comprises a current determination circuit configured to calculate the output current as expressed as: I_{OUT}=(V₀−V_{OUT-FB})/R_{LL}, wherein:
I_{OUT} represents the output current calculated by the current determination circuit;
V₀ represents a level of the output voltage when the output current is equal to zero;
V_{OUT-FB} represents the feedback voltage indicating the present level of the output voltage at the voltage output; and
R_{LL} represents a load line of the multi-phase voltage regulator.
